(19) United States
(12) Patent Application Publication
(10) Pub. No.: US 2007/0003216 A1
(43) Pub. Date: Jan. 4, 2007

(54) Information recording apparatus and information recording method

(75) Inventor: Hiroyoshi Iketo, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Kabushiki Kaisha Toshiba

(21) Appl. No.: 11/476,784

(22) Filed: Jun. 29, 2006

(30) Foreign Application Priority Data
Jun. 30, 2005 (JP) 2005-193059

(51) Int. Cl. H04N 5/445; H04N 5/91

(52) U.S. Cl. 386/83; 725/58

(57) ABSTRACT

According to one embodiment, an information recording apparatus comprises a receiving unit which receives a broadcast content including a program, an acquisition unit which acquires program information from the received broadcast content, and a control unit which records the received broadcast content such that the content is classified in more detailed units than program units based on the acquired program information.

### CROSS-REFERENCE TO RELATED APPLICATIONS

This application is based upon and claims the benefit of priority from Japanese Patent Application No. 2005-193059, filed Jun. 30, 2005, the entire contents of which are incorporated herein by reference.

### BACKGROUND

1. Field

One embodiment of the invention relates to an improvement of an information recording apparatus and an information recording method for automatically recording a television broadcast program, for example.

2. Description of the Related Art

As is well known, in recent years, the digitization of television broadcasting has been promoted. For example, in Japan, not only satellite digital broadcasting, such as broadcasting satellite (BS) digital broadcasting and 110-degree communication satellite (CS) digital broadcasting, but also terrestrial digital broadcasting has been started.

A digital broadcasting receiving apparatus that receives such digital television broadcasting incorporates a large-capacity digital recording apparatus, such as a hard disk drive (HDD), and thereby is capable of digitally recording received content and playing back the recorded content.

To automatically record a television broadcast content, at the present time, methods are available such as a method of timer recording a necessary program using G-Code and a method of selecting a desired program from an electronic program table which is created based on electronic program guide (EPG) information acquired through broadcasting, a network, or the like, and then timer recording the selected program.

More specifically, any of automatic recording means in the current state can perform only recording on a program-by-program basis. Thus, for example, to record a single program (music program) such that the program is broken down into more detailed units (classified by artist) to be recorded, there is a need to automatically record a program and then edit the program manually by a user, causing inconvenience to handling.

Jpn. Pat. Appln. KOKAI Publication No. 2002-352560 discloses the following configuration. Based on a text string in additional information added to music data, a search is performed on the names of folders provided in a recording medium which serves as a recording destination, a folder having a name that matches the text string in the additional information is specified as a storage destination of the music data, and then, the music data is recorded.

In addition, Jpn. Pat. Appln. KOKAI Publication No. 2000-013759 discloses the following configuration. Program information is extracted from decoded video information and the extracted program information is processed such that the program information is classified into information valid at a broadcast time and information necessary for program recording, whereby the program information can be effectively used.

Furthermore, Jpn. Pat. Appln. KOKAI Publication No. 2005-044434 discloses a configuration in which folders with the names of artists that are already recorded on a hard disk are created and displayed or a new folder is created, a folder corresponding to an artist on a compact disk (CD) is selected, and data such as music information is inputted and recorded on the hard disk.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an illustrative perspective view showing an external appearance of a television broadcast receiving apparatus according to an embodiment of the present invention;

FIG. 2 is an illustrative block configuration diagram showing a signal processing system of the television broadcast receiving apparatus according to the embodiment;

FIG. 3 is an illustrative flowchart showing an exemplary recording operation of the television broadcast receiving apparatus according to the embodiment;

FIG. 4 is an illustrative diagram showing exemplary recording results obtained by the television broadcast receiving apparatus according to the embodiment;

FIG. 5 is an illustrative diagram showing other exemplary recording results obtained by the television broadcast receiving apparatus according to the embodiment;

FIG. 6 is an illustrative view showing a PC to which the embodiment is applied; and

FIG. 7 is an illustrative view showing a mobile phone to which the embodiment is applied.

### DETAILED DESCRIPTION

Various embodiments according to the invention will be described hereinafter with reference to the accompanying drawings. In general, according to one embodiment of the invention, an information recoding apparatus comprises a receiving unit which receives a broadcast content including a program; an acquisition unit which acquires programs information from the received broadcast content; and a control unit which records the received broadcast content such that the content is classified in more detailed units than program units based on the acquired program information.

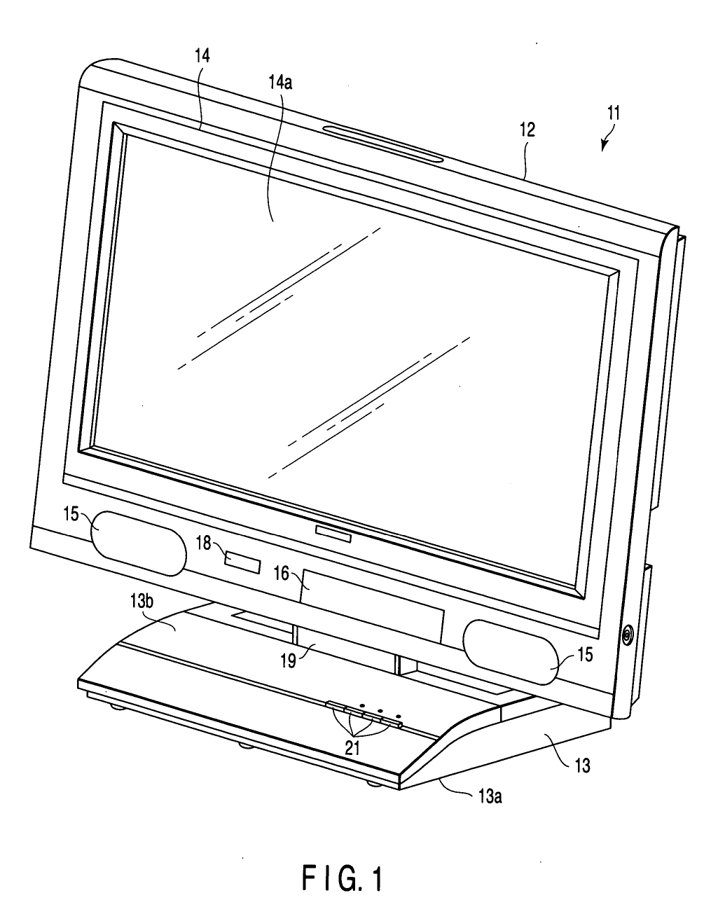

FIG. 1 is a view showing a front side external appearance of a television broadcast receiving apparatus 11 which is described in the present embodiment. More specifically, the television broadcast receiving apparatus 11 is mainly composed of a thin cabinet 12 serving as a main body of the apparatus and formed in a substantially square shape and a stand 13 that supports the cabinet 12 in a standing manner.

On the front side of the cabinet 12, there are arranged an exposed display screen 14a of a video display unit 14 composed of, for example, a flat liquid crystal display panel; a pair of speakers 15; an operation unit 16; and a photoreceptor unit 18 that receives operation information which is sent from a remote controller (not shown in FIG. 1) 17 which will be described later.

The stand 13 is formed in a substantially thin box shape and configured such that a bottom plate 13a which is its one plane is placed on a predetermined base (not shown) which is horizontally placed. A supporting member 19 projecting upwardly from substantially the center of a top plate 13b which is a plane on the opposite side of the plane placed on the base is coupled to a rear side of the cabinet 12, whereby the stand 13 supports the cabinet 12 in a standing manner.

The stand 13 includes therein an HDD unit (not shown in FIG. 1) 20 which will be described later. At a portion of the top plate 13b of the stand 13 that projects further toward the front side than the cabinet 12, there are arranged a plurality (four in the drawing) of operators 21 which can be operated by pressing and are used to control the HDD unit 20 to bring into a record, playback, or stop state.

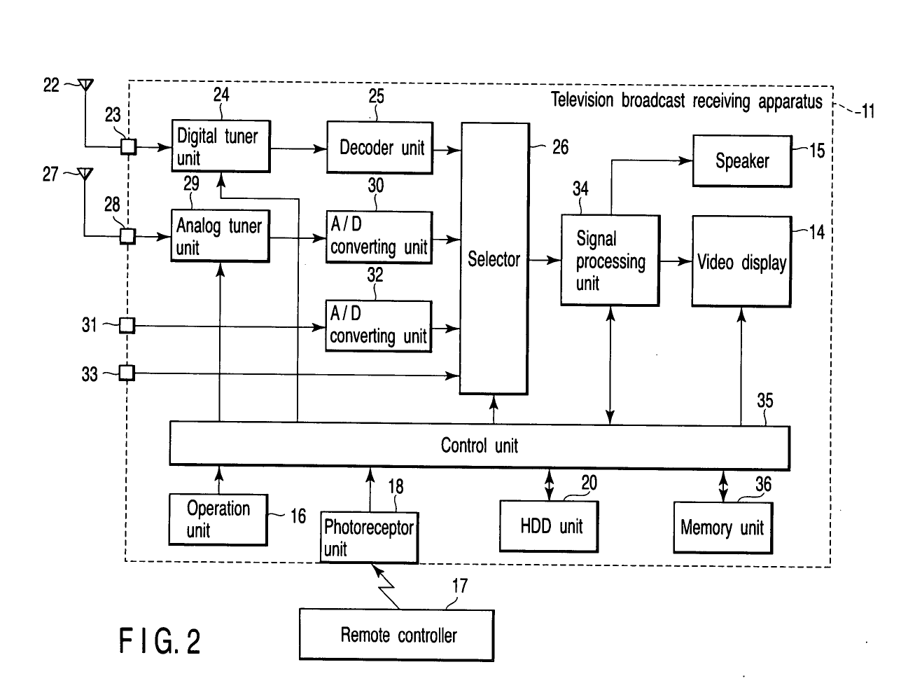

FIG. 2 is a diagram schematically showing a signal processing system of the television broadcast receiving apparatus 11. Various circuit blocks that compose the signal processing system are mainly arranged at a location inside the cabinet 12 and close to the rear side, i.e., around a backside of the display screen 14a of the video display unit 14.

Digital television broadcast signals received by an antenna 22 for receiving digital television broadcasting are supplied to a digital tuner unit 24 through an input terminal 23. The tuner unit 24 selects a signal of a desired channel from the inputted digital television broadcast signals and demodulates the selected signal. Then, a signal outputted from the tuner unit 24 is supplied to a decoder unit 25 and subjected to, for example, an orthogonal frequency division multiplexing (OFDM) decoding process, and then, the decoded signal is supplied to a selector 26.

Analog television broadcast signals received by an antenna 27 for receiving analog television broadcasting are supplied to an analog tuner unit 29 through an input terminal 28. The tuner unit 29 selects a signal of a desired channel from the inputted analog television broadcast signals and demodulates the selected signal. Then, a signal outputted from the tuner unit 29 is digitized by an analog/digital (A/D) converting unit 30, and then, the digitized signal is outputted to the selector 26.

Analog video and audio signals supplied to an input terminal 31 for analog signals are supplied to an A/D converting unit 32 and digitized, and then, the digitized signals are outputted to the selector 26. Digital video and audio signals supplied to an input terminal 33 for digital signals are directly supplied to the selector 26.

The selector 26 selects one from four types of input digital video and audio signals and supplies the selected one to a signal processing unit 34. The signal processing unit 34 performs predetermined signal processing on an inputted digital video signal to provide video display on the video display unit 14. For the video display unit 14, for example, a flat panel display composed of a liquid crystal display, a plasma display, or the like, may be employed. In addition, the signal processing unit 34 performs predetermined signal processing on an inputted digital audio signal to convert the signal into an analog signal and outputs the analog signal to the speakers 15, whereby the audio is played back.

In the television broadcast receiving apparatus 11, various operations including the aforementioned various receiving operations are comprehensively controlled by a control unit 35. The control unit 35 is a microprocessor that incorporates a central processing unit (CPU) and the like. The control unit 35 receives, through the photoreceptor unit 18, operation information from the operation unit 16 or the operators 21 (not shown in FIG. 2) or operation information sent from the remote controller 17, and thereby controls each unit such that the operation content is reflected.

In this case, the control unit 35 uses a memory unit 36. The memory unit 36 mainly includes a read only memory (ROM) having stored therein a control program which is executed by the CPU; a random access memory (RAM) that provides a work area to the CPU; and a nonvolatile memory in which various setting information, control information, and the like are stored.

The control unit 35 is connected to the HDD unit 20 included in the stand 13. This enables the television broadcast receiving apparatus 11 to record digital video and audio signals selected by the selector 26 by use of the HDD unit 20 and to play back the digital video and audio signals recorded in the HDD unit 20 for viewing and listening.

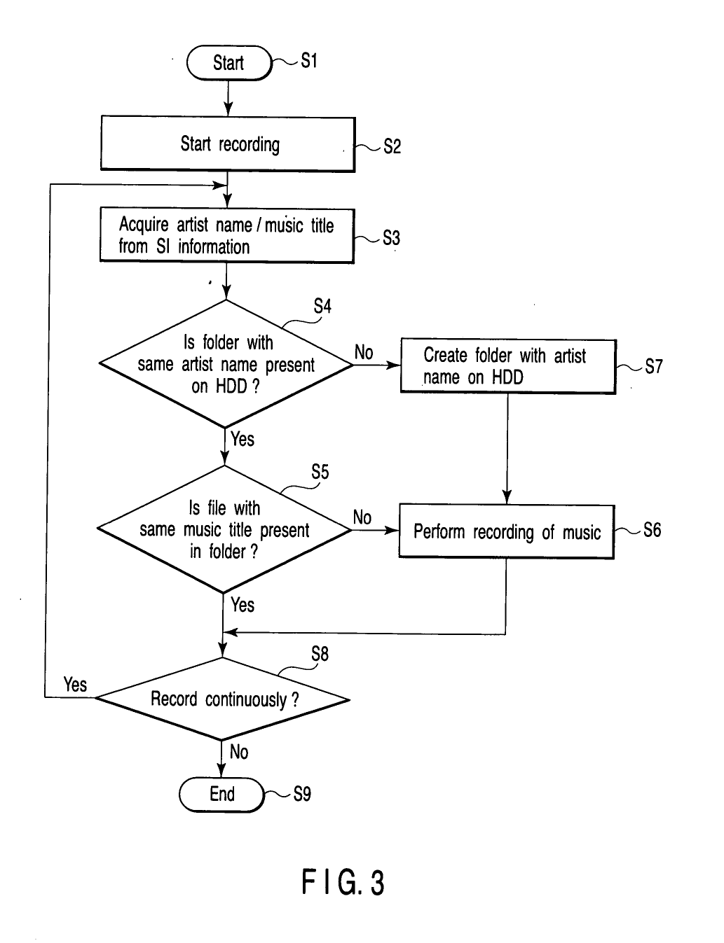

FIG. 3 is an illustrative flowchart showing the processing operation of recording in the HDD unit 20 broadcast content received by the television broadcast receiving apparatus 11. In this case, FIG. 3 explains an exemplary processing operation in which, when a specialized channel devoted to music or the like is received and a music program is recorded, music is automatically classified by artist and recorded.

More specifically, when processing starts (block S1), the control unit 35 detects in block S2 that a recording operation has started. The start of a recording operation indicates a recording operation started by the user manually operating the operation unit 16, the remote controller 17, or the like, or a recording operation started as the timer recording start time is reached.

Then, in block S3, the control unit 35 acquires information indicating the name of an artist and the title of music from service information (SI) which is program information sent and added to each program in ground wave digital broadcasting. Thereafter, in block S4, the control unit 35 determines whether or not a folder with the same artist name as the acquired artist name is already present in the HDD unit 20.

If it is determined that a folder with the same artist name as the artist name acquired in block S3 is already present in the HDD unit 20 (Yes), the control unit 35 determines, in block S5, whether or not a file with the same music title as the music title acquired in block S3 is already present in the folder.

If it is determined that a file with the same music title as the music title acquired in block S3 is not present (No), the control unit 35 records, in block S6, video and audio signals corresponding to the music in the HDD unit 20 by using the music title acquired in block S3 as its file name.

On the other hand, if it is determined that a folder with the same artist name as the artist name acquired in block S3 is not present in the HDD unit 20 (No), the control unit 35 newly creates, in block S7, a folder with the artist name acquired in block S3 in the HDD unit 20.

Thereafter, in block S6, the control unit 35 records video and audio signals corresponding to the music by the artist in the newly created folder using the music title acquired in block S3 as its file name.

After block S6, or if it is determined that a file with the same music title as the music title acquired in block S3 is present in the folder (Yes), the control unit 35 determines, in block S8, whether or not recording is continuously performed. If it is determined that recording is performed (Yes), the control unit 35 moves to the process of block S3; and if it is determined that recording is not performed (No), processing ends (block S9).

The case in which recording is not continuously performed indicates the case in which the recording operation is stopped by the user manually operating the operation unit 16, the remote controller 17, or the like, or the case in which the recording operation is stopped as the timer recording end time is reached.

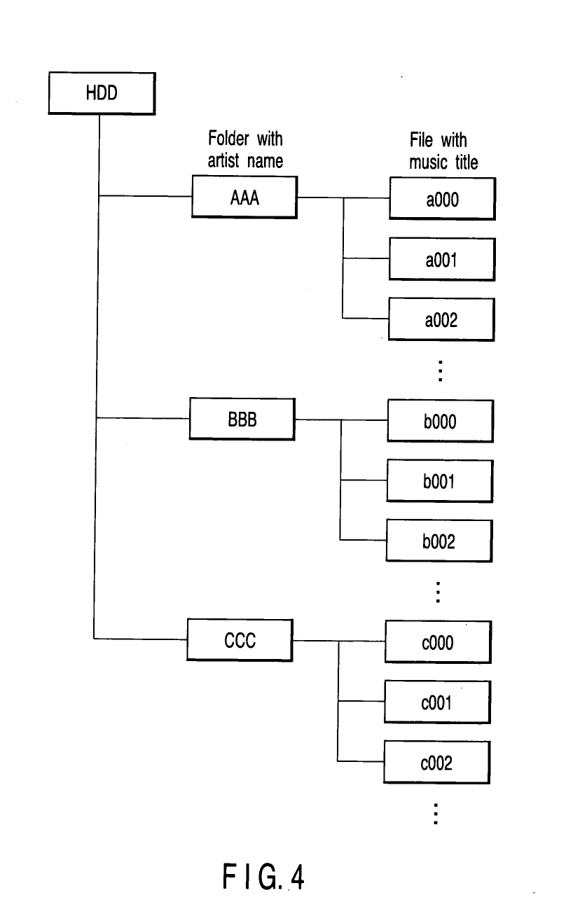

FIG. 4 is a diagram showing exemplary results classified and recorded in the HDD unit 20 in the aforementioned manner. In FIG. 4, “AAA”, “BBB”, and “CCC” represent artist names, and “a000”, “a001”, “a002”, and the like represent music tiles.

Upon broadcasting, data is sent as consecutive data and with artist names and music titles being arranged in irregular order. However, by performing a process based on the flowchart shown in FIG. 3, the data is automatically recorded in the HDD unit 20 so as to be classified by an artist name and divided by a music title, as shown in FIG. 4.

According to the aforementioned embodiment, information indicating an artist name and a music title is acquired from SI and video and audio signals corresponding to music by the artist are recorded in a folder created with the artist name using the music title as its file name. Consequently, a broadcast content can be automatically classified in more detailed units than program units and recorded, whereby user handling can be made convenient.

Note that an artist name and a music title in SI are expressed in text data and the expression form may vary depending on different programs or different broadcast stations. For example, in the case of the artist name “AAA”, it may be sent from a broadcast station such that a space is inserted between the letters such as “A A A” or that one-byte characters are used such as “AAA”.

In this case, when recording is performed based on the flowchart shown in FIG. 3, three types of folders “AAA”, “A A A”, and “AAA” are created even though the same artist is specified.

To avoid this problem, it is desirable to provide a function of allowing the user to, after recording, perform manual setting, for example, such that recording is performed from next time by integrating the aforementioned three types of folder names into a representative folder name “AAA”.

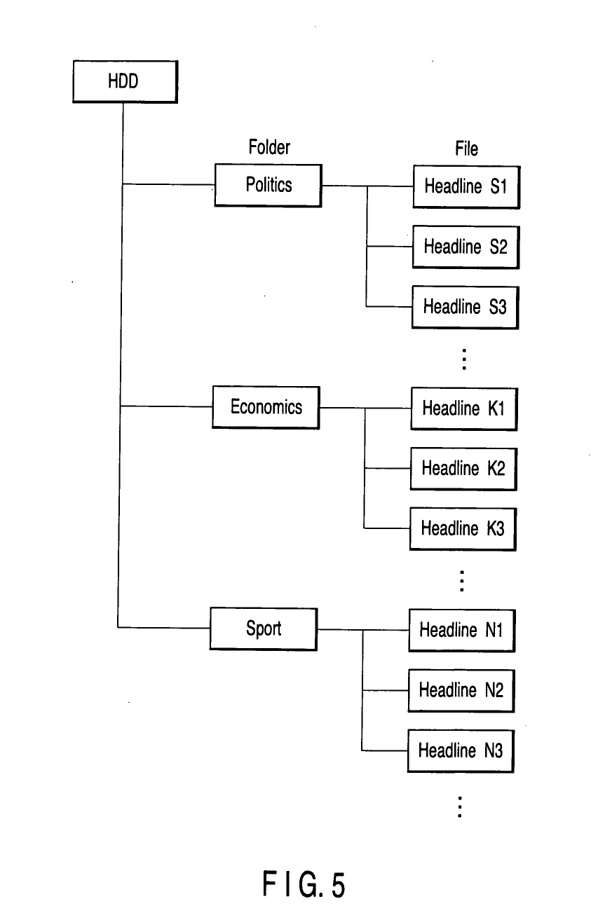

Although the embodiment describes classifying and recording of a music program, the present invention can be applied to classifying and recording not only of a music program but also of various programs. For example, as shown in FIG. 5, a news program may be classified by folder names such as “politics”, “economics”, and “sport”, and signals may be classified and recorded in appropriate folders using headlines of news as their file names.

For a folder name, a file name, and the like, names that are included in SI can be used. Therefore, a function of allowing the user to select a desired name from names included in SI and to use the selected name as a folder name or a file name may be provided.

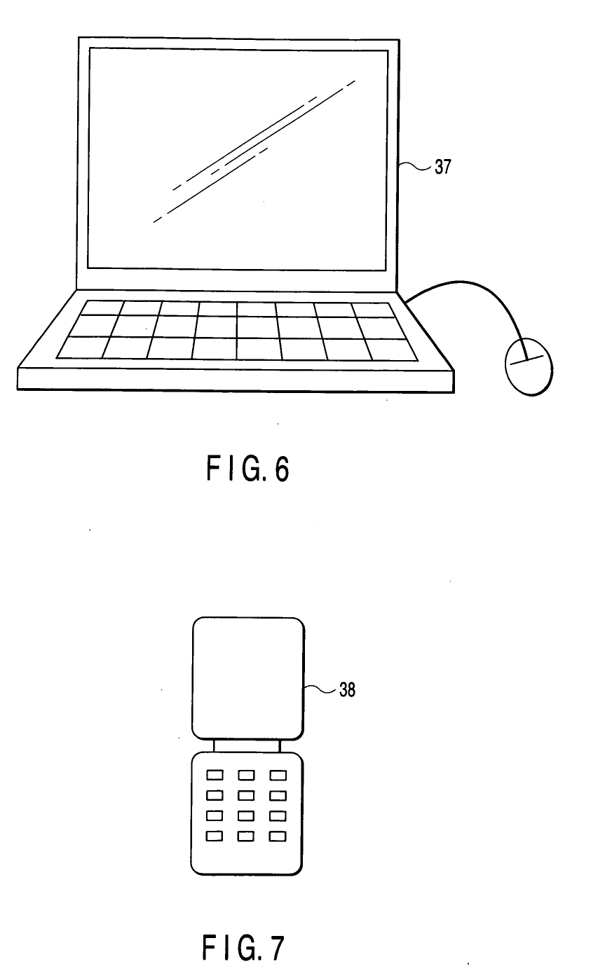

Although in the embodiment, a description is made using the television broadcast receiving apparatus 11 as an example, the present invention is applicable to a wide range of fields such as a personal computer (PC) 37 shown in FIG. 6, and a mobile phone 38 shown in FIG. 7.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording apparatus comprising:
a receiving unit configured to receive a broadcast content including a program;
an acquisition unit configured to acquire program information from the broadcast content received by the receiving unit; and
a control unit configured to record the broadcast content received by the receiving unit such that the content is classified in more detailed units than program units based on the program information acquired by the acquisition unit.

2. An information recording apparatus according to claim 1, wherein the control unit comprises:
a folder creating unit configured to create a folder to be used for classifying the broadcast content received by the receiving unit in more detailed units than program units based on the program information acquired by the acquisition unit; and
a recording unit configured to record, as a file, the broadcast content classified in more detailed units than program units based on the program information acquired by the acquisition unit, in the folder created by the folder creating unit.

3. An information recording apparatus according to claim 2, wherein the folder creating unit is configured to create the folder with a name which is included in the program information acquired by the acquisition unit and by which the broadcast content is classified in more detailed units than program units.

4. An information recording apparatus according to claim 2, wherein the folder creating unit is configured to, when a folder with a same name as a name included in the program information acquired by the acquisition unit is not present, create a folder with the name included in the program information.

5. An information recording apparatus according to claim 2, wherein the folder creating unit is configured to create folders classified by an artist name based on program information on a music program acquired by the acquisition unit.

6. An information recording apparatus according to claim 2, wherein the folder creating unit is configured to create a folder corresponding to any one of fields including politics, economics, and sport, based on program information on a news program acquired by the acquisition unit.

7. An information recording method comprising:
a first block of receiving a broadcast content including a program;
a second block of acquiring program information from the broadcast content received in the first block; and
a third block of recording the broadcast content received in the first block such that the content is classified in more detailed units than program units based on the program information acquired in the second block.

8. An information recording method according to claim 7, wherein the third block comprises:
a fourth block of creating a folder to be used for classifying the broadcast content received in the first block in more detailed units than program units based on the program information acquired in the second block; and
a fifth block of recording, as a file, the broadcast content classified in more detailed units than program units based on the program information acquired in the second block, in the folder created in the fourth block.

9. An information recording method according to claim 8, wherein, in the fourth block, the folder is created with a name which is included in the program information acquired in the second block and by which the broadcast content is classified in more detailed units than program units.

10. An information recording method according to claim 8, wherein, in the fourth block, when a folder with a same name as a name included in the program information acquired in the second block is not present, a folder is created with the name included in the program information.

11. An information recording method according to claim 8, wherein, in the fourth block, folders classified by an artist name are created based on program information on a music program acquired in the second block.

12. An information recording method according to claim 8, wherein, in the fourth block, a folder corresponding to any one of fields including politics, economics, and sport is created based on program information on a news program acquired in the second block.
